(19) United States
(12) Patent Application Publication
(10) Pub. No.: US 2006/0157080 A1
(43) Pub. Date: Jul. 20, 2006

(54) CLEANING METHOD FOR SEMICONDUCTOR WAFER

(76) Inventors: Teng-Chun Tsai, Hsin-Chu City (TW); Hsin-Kun CHU, Hsin-Chu County (TW); Chien-Chung Huang, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,771

(22) Filed: Jan. 20, 2005

(51) Int. Cl. C23G 1/02; B08B 7/00; C23G 1/00

(52) U.S. Cl. 134/3; 134/6; 134/26; 134/2

(57) ABSTRACT

A cleaning method according to the present invention is provided. The method includes at least two stages of cleaning processes. In the first stage, dilute HF is provided as a cleaning solution, and a brushing process is performed. In the second stage, dilute HF is also provided as a cleaning solution, and a washing process is performed. A pre-cleaning process and a post-cleaning process are further provided according to the present invention. The pre-cleaning method is performed before the brushing process, and the post-cleaning method is performed after the washing process. In addition, the pre-cleaning process and the post-cleaning process are a brushing process or a washing process adopting NH₄OH as a cleaning solution.

### BACKGROUND OF INVENTION

1. Field of the Invention

The present invention is related to a cleaning method for cleaning a semiconductor wafer. More particularly, the present invention is related to a cleaning method for cleaning a chemical mechanical polished semiconductor wafer.

2. Description of the Prior Art

As elements of a wafer become smaller and more integrated, the requirement of controlling the depth of focus of the lithography grows as well. As a result, in VLSI and ULSI, a plurality of layers of metal interconnects and low K dielectric materials are widely adopted to connect elements of a semiconductor wafer, so as to form high-density circuits. However, these elements form severe topographies on the semiconductor wafer, and thus make deposition or pattern transfer processes difficult. Therefore, a planarization process has to be performed on the wafer surface before further processing.

Conventional planarization is mostly performed using spin in glass (SOG) and resist etch back (REB). However, in processes with feature sizes smaller than 250 nm, global planarization can not be performed by using SOG or REB. Therefore, a chemical mechanical polishing (CMP) which can be applied in small feature size processes is adopted in VLSI and ULSI for planarization. Generally, if all parameters are appropriate, planarity of up to 94% can be reached.

Generally, in a CMP process, appropriate slurry and mechanical polishing is used to remove the non-uniform target thin film on the surface of a wafer, so as to obtain a regular and planar surface. The slurry includes chemical agents and abrasives. The chemical agents may be pH buffers, oxidants, surfactants or the like, and the abrasives may be silica, alumina, zirconium oxide, or the like. The chemical reactions evoked by the chemical agents and the abrasion between the wafer and the polishing pad can planarize the surface of the wafer.

Furthermore, sometimes slurry with high selectivity is provided to meet the requirements of the CMP process. For example, in a deep trench isolation (DTI) process, a copper damascene process, and particularly, a shallow trench isolation (STI) process, slurry with high selectivity between silicon nitride and silicon oxide is provided.

In a STI process, high selectivity slurry (HSS) can prevent a semiconductor substrate from being exposed due to over polishing. Please refer to FIG. 1. A patterned silicon nitride 2 covers a semiconductor substrate 4 as a mask. The unmasked portions of the semiconductor substrate 4 are etched to form trenches 8. Following that, a silicon oxide is deposited, for example, using high-density plasma chemical vapor deposition (HDPCVD), wherein an etch process is performed at the same time to prevent openings of the trenches from being physically clogged by the silicon nitride. If the openings 8 are clogged, the trenches will not be able to be filled with the silicon oxide, which leads to defects in elements. However, the silicon oxide will form uneven topography according to the profile of the wafer 10 surface. Therefore, a CMP process is performed to remove the surplus silicon oxide 6 above the silicon nitride 2 to planarize the surface of the wafer 10 (shown as the dotted line). Furthermore, the hard silicon nitride 2 above the semiconductor substrate 4 serves as a stop layer of the CMP, so as to prevent over polishing that exposes the semiconductor substrate 4. In addition, slurry with high selectivity between silicon oxide and silicon nitride prevents the silicon nitride 2 from removed while polishing the silicon oxide 6, so as to protect the semiconductor substrate 4 from being exposed.

The HSS is especially useful in fabricating highly integrated semiconductor wafers. In a process that fabricates elements with small feature size, the thickness of the silicon nitride 2 is small. As a result, portions of the silicon nitride 2 may be removed while polishing the silicon oxide 6 and may cause the semiconductor substrate 4 to be exposed. Considering the situation, the HSS is used in a STI CMP process with a feature size of 130 nm and beyond to produce elements with higher reliability.

However, although using HSS in a STI CMP process may enhance the polishing performance, it may cause microscratches on the wafer, and leaving residues. The microscratches may be prevented by adjusting the polishing process, while the slurry residues problem is resolved through a post clean process. The slurry residues and shattered pieces resulting from polishing may cause collapse of oxides, electric leakages or other defects. Therefore, an effective post clean process is necessary to improve the yield rate and the reliability of the wafers.

In a conventional STI CMP process for polishing oxide, ammonia (NaOH) or ammonia and dilute hydrogen fluoride (DHF) are used as clean solutions to perform the post clean process, wherein a brushing process is not included in such a post clean process. However, in a STI CMP process adopting HSS, the above post clean process is not able to remove the residues thoroughly. This is because that HSS comprises special surfactants, which are used to control the removing rate of silicon nitride and silicon oxide, and those surfactants may cause more severe residues problems.

As a result, in order to reduce the slurry residues caused by HSS, improved post clean processes are provided. One of the improved processes is to provide a cleaning brush to the surface of the wafer so as to brush the wafer. Such a cleaning process is able to remove the residues effectively, and the oxide loss of the surface is rare. However, such kind of cleaning process may lead to non-uniformity of the silicon nitride. Consequently, the uniformity of the STI step height is sacrificed. Nevertheless, the uniformity of the STI step height is crucial to processes with a feature size of 90 nm or beyond, and thus has great influence on increasing the integrity of the wafer. As a result, there remains need within the art for a cleaning method that is able to remove the slurry residues thoroughly without sacrificing the uniformity of STI step height.

### SUMMARY OF INVENTION

It is therefore a primary object of the claimed invention to provide a cleaning method to solve the above-mentioned problems. More specifically, the claimed invention provides a post cleaning method for STI CMP process using HSS that is able to remove most of the slurry residues while not sacrificing the uniformity of STI step height.

According to the claimed invention, a cleaning method for a semiconductor wafer is disclosed. According to the cleaning method, a brushing process using DHF is performed. Following that, a washing process using DHF is performed.

It is an advantage of the claimed invention that it provides at least two steps of a cleaning process that can solve problems faced in the prior art. The brushing step improves the slurry residues issue in the prior art, so as to prevent defects on the surface of the wafer. Another step, in which the brush is not contact with the wafer, can prevent severe loss of the silicon nitride that results from long duration of brushing. In other words, decreasing brushing time appropriately may assure the uniformity of the silicon nitride, and thus maintains the reliability of the wafer.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a sectional view of the STI structure in the prior art;

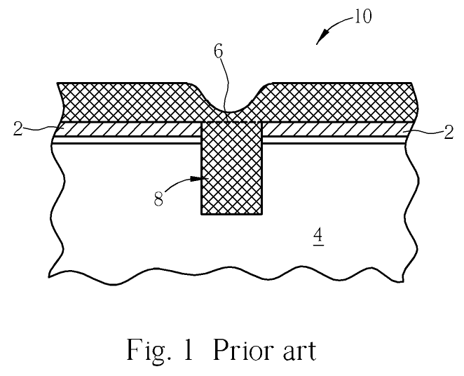

FIG. 2 is a flow chart illustrating an embodiment according to the present invention;

FIG. 3 is a flow chart illustrating another embodiment according to the present invention;

FIG. 4 is a flow chart illustrating still another embodiment according to the present invention; and

FIG. 5 is a table comparing the uniformity of the thickness of the silicon nitride in wafers brushed throughout the cleaning process and that in wafers brushed only in parts of the cleaning process.

### DETAILED DESCRIPTION

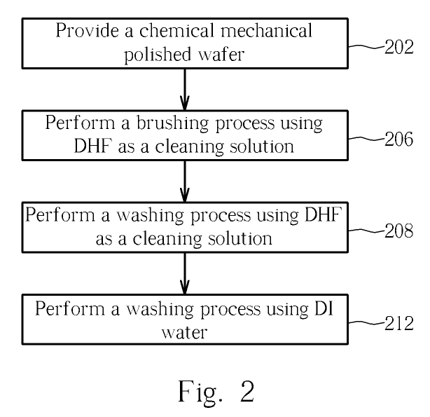

Please refer to FIG. 2. FIG. 2 illustrates a flow chart of one embodiment according to the present invention. As shown in FIG. 2, a dilute hydrogen fluoride (DHF) solution is provided on the chemical mechanical polished wafer, while the wafer is brushed for 45 seconds (step 206). Following that, the DHF solution is continually provided on the wafer for 15 seconds without brushing the wafer (step 208). At last, a washing process using DI water may be performed to wash away the cleaning solution and other remainders (step 212).

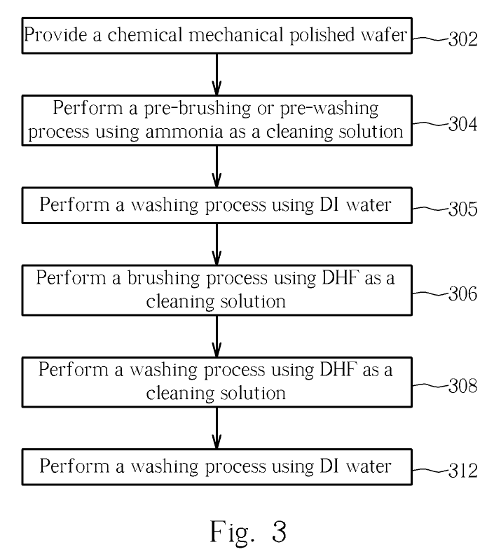

Please refer to FIG. 3. FIG. 3 illustrates a flow chart of another embodiment according to the present invention. As shown in FIG. 3, an ammonia (NH₄OH) solution is provided on the chemical mechanical polished wafer to perform a pre-brushing process or a pre-washing process (step 304). After that, DI water is provided to wash out the ammonia solution (step 305). A DHF solution is then provided on the wafer, while the wafer is brushed for 45 seconds (step 306). Following that, the DHF solution is continually provided on the wafer for 15 seconds without brushing the wafer (step 308). At last, a washing process using DI water may be performed to wash away the cleaning solution and other remainders (step 312).

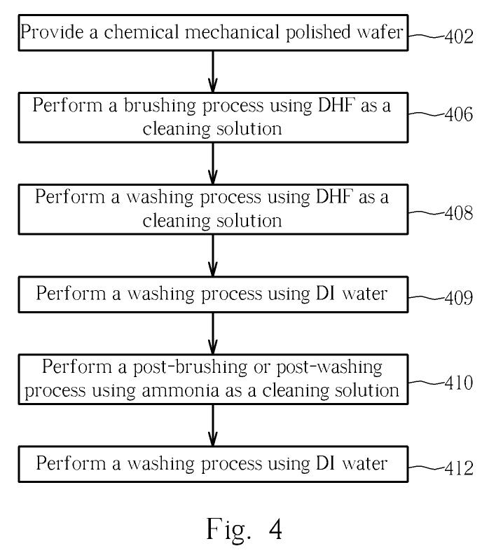

Please refer to FIG. 4. FIG. 4 illustrates a flow chart of still another embodiment according to the present invention. As shown in FIG. 4, a DHF solution is provided on the chemical mechanical polished wafer while the wafer is brushed for 45 seconds (step 406). Following that, the DHF solution is continually provided on the wafer for 15 seconds without brushing the wafer (step 408). After that, DI water is provided to wash out the DHF solution (step 409). An ammonia solution is provided on the chemical mechanical polished wafer to perform a post-brushing process or a post-washing process (step 410). At last, a washing process using DI water may be performed to wash away the cleaning solution and other remainders (step 412).

In another embodiment according to the present invention, a DHF solution is provided on the chemical mechanical polished wafer while the wafer is brushed for 35 seconds. Following that, the DHF solution is continually provided on the wafer for 25 seconds without brushing the wafer. In other words, the time for the brushing process and the washing process can be adjusted according to requirements. Generally, the time used for the brushing process is one time to three times that of the washing process. Reducing the time of the brushing process in conventional methods enables slurry remainders to be removed efficiently while not leaving scratches on the surface of the wafer.

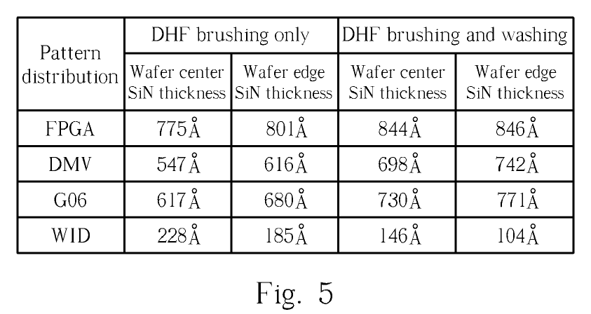

Please refer to FIG. 5. FIG. 5 is a table comparing the uniformity of the thickness of the silicon nitride in wafers brushed throughout the cleaning process and that in wafers brushed only in parts of the cleaning process. In the table, FPGA indicates the regions in which STI pattern distribution is sparse; DMV indicates the regions in which STI pattern distribution is dense; G06 indicates the regions in which STI pattern density is 50%; and WID is the difference of the silicon nitride thickness between FPGA and DMV.

According to FIG. 5, in wafers brushed throughout the cleaning process, the thickness of the silicon nitride is non-uniform; while in those brushed only in part of the cleaning process, the thickness of the silicon nitride is more uniform, which means the difference of the thickness between the silicon nitride in the central portion and that in the edge portion is finer.

Therefore, it is an advantage of the present invention that it provides a method for thoroughly cleaning a chemical mechanical polished wafer without reducing the uniformity of the wafer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cleaning method for a semiconductor wafer, comprising:
performing a brushing process using dilute hydrogen fluoride (DHF) as a cleaning solution; and
performing a washing process using DHF as a cleaning solution.

2. The cleaning method according to claim 1, wherein the semiconductor wafer is chemical mechanical polished.

3. The cleaning method according to claim 2, wherein the chemical mechanical polishing uses high selectivity slurry to form at least a shallow trench isolation in the semiconductor wafer.

4. The cleaning method according to claim 1, wherein processing time of the brushing process is one time to three times that of the washing process.

5. The cleaning method according to claim 1, wherein, before the brushing process using DHF as cleaning solution, the cleaning method further comprises:
performing a pre-brushing process using ammonia (NH₄OH); and
performing a washing process using DI water.

6. The cleaning method according to claim 1, wherein, before the brushing process using DHF as cleaning solution, the cleaning method further comprises:
performing a pre-washing process using ammonia; and
performing a washing process using DI water.

7. The cleaning method according to claim 1, wherein, after the washing process using DHF as cleaning solution, the cleaning method further comprises:
performing a post-brushing process using ammonia; and
performing a washing process using DI water.

8. The cleaning method according to claim 1, wherein, after the washing process using DHF as cleaning solution, the cleaning method further comprises:
performing a post-washing process using ammonia; and
performing a washing process using DI water.

9. The cleaning method according to claim 1, wherein, after the washing process using DHF as cleaning solution, the cleaning method further comprises a washing process using DI water.

10. A cleaning method for a chemical mechanical polished semiconductor wafer, comprising:
performing a cleaning process using a first cleaning solution;
performing a brushing process using a second cleaning solution;
performing a washing process using a second cleaning solution; and
performing a washing process using DI water.

11. The cleaning method according to claim 10, wherein the chemical mechanical polishing uses high selectivity slurry to form at least a shallow trench isolation in the semiconductor wafer.

12. The cleaning method according to claim 10, wherein processing time of the brushing process is one time to three times that of the washing process.

13. The cleaning method according to claim 10, wherein the first cleaning solution is ammonia and the second cleaning solution is DHF.

14. The cleaning method according to claim 13, wherein the cleaning process is a pre-brushing process or a pre-washing process.

15. The cleaning method according to claim 10, wherein, after the cleaning process, the cleaning method further comprises performing a washing process using DI water.

16. A cleaning method for a chemical mechanical polished semiconductor wafer, comprising:
performing a brushing process using a first cleaning solution;
performing a washing process using a first cleaning solution;
performing a cleaning process using a second cleaning solution; and
performing a washing process using DI water.

17. The cleaning method according to claim 16, wherein the chemical mechanical polishing uses high selectivity slurry to form at least a shallow trench isolation in the semiconductor wafer.

18. The cleaning method according to claim 16, wherein processing time of the brushing process is one time to three times that of the washing process.

19. The cleaning method according to claim 16, wherein the first cleaning solution is DHF and the second cleaning solution is ammonia.

20. The cleaning method according to claim 16, wherein the cleaning process is a post-brushing process or a post-washing process.
